(19) United States
(12) Patent Application Publication
(10) Pub. No.: US 2016/0110900 A1
(43) Pub. Date: Apr. 21, 2016

(54) System And Method For Dynamically Combining Images To Display Textual Content In The Form Of An Image

(71) Applicants: Mateen Moosa, Chicago, IL (US); Marin Petkov, Chicago, IL (US); Andrew Lindsay, Glenview, IL (US); Brian D. Young, Chicago, IL (US)

(72) Inventors: Mateen Moosa, Chicago, IL (US); Marin Petkov, Chicago, IL (US); Andrew Lindsay, Glenview, IL (US); Brian D. Young, Chicago, IL (US)

(21) Appl. No.: 14/518,177

(22) Filed: Oct. 20, 2014

(51) Int. Cl. G06T 11/60

(52) U.S. Cl. CPC G06T 11/60; G06T 2210/32

(57) ABSTRACT

The system and method for providing a composite image corresponding to a textual message. The composite image is generated by receiving a text message, parsing out styling information, using predetermined size and spacing for combinations of typographical characters in combinations with a graphics editing routine which allows for the recognition and translation of text into a series of images which can then be presented to a viewer as a composite image.

### FIELD OF INVENTION

The present invention relates to a system and process to calculate size and position to combine images of typographical characters to display textual content in the form of an image resulting in better performance and consistency across various device types compared to using web-fonts. More specifically, the present invention relates to the use of predetermined size and spacing for combinations of typographical characters in combinations with a graphics editing routine which allows for the recognition and translation of text into a series of images which can then be presented to a viewer as a composite image.

### BACKGROUND OF THE INVENTION

Web typography—the use of fonts on messages communicated over the World Wide Web—creates a number of challenges. When HTML, was first created, font faces and styles were controlled exclusively by the settings of each Web browser. More recently, web-safe fonts (fonts likely to be present on a wide range of computer systems) have been used by Web content authors to increase the likelihood that content displays in their chosen font. If a visitor to a Web site does not have the specified font, however, the visitor's browser tries to select a similar alternative, based on the author-specified fallback fonts and generic families or it uses font substitution defined in the visitor's operating system. Indeed, even when a given web font is available, the presentation of a text message may differ across computer platforms, e.g., web fonts Chrome on Mac displays differently that web fonts chrome on a PC platform.

Moreover, some commercial foundries object to the redistribution of their fonts absent payment of an expensive license fee. To complicate matters further, depending upon the need of the sender or the limitations of the message, it may be desirable to adjust the size of the text to fit a given display box. In particular, in the area of online advertising, it may be desirable to scale down an image in order to provide the same format and content of a message in a banner advertisement or the like.

Thus, the present state of the art reflects a need for a system and method which provides a flexible tool for sending text content messages without the limitations of web fonts across a variety of display box sizes without creating undesirable alterations in the format of the message.

### DESCRIPTION OF THE PRIOR ART

Those of skill in the art understand that vector based graphics programs can be used to generate images to convey a message. Indeed, those of skill in the art understand that a vector based graphics application can adjust the scale of an image without impacting the quality of the image (unlike raster based approaches). However, vector based approaches have limitations which applicants submit make them impractical for the present invention. For instance, vector images come up more slowly on client machines due to the inability to preload such changes in scale, which is undesirable in the process of providing online advertisements.

Also, those of skill are aware a variety of tools for extracting text and converting that information into one or more images which approximate the content of the text message. For instance, US Patent application U.S.2007239631A1 discloses a method for generating a graphical image to convey an intended message. The method enables a user to select one or more graphics from a graphic language database, wherein the annotations (or descriptions) associated with each graphic selected can be combined to convey the intended message. Such an approach, however fails to set forth a process for converting a textual message into an image conveying the same text message, or for providing an altered size text image which has the same format and content. Similarly, EP 2290924 A1 teaches generating graphical image strings that graphically represent the full meaning of the content of text messages, a text message containing at least one sentence to be converted into graphical format is first analyzed to identify, for each sentence: the subject; the at least one verb associated with the subject, if any; and the substantives not referring to a person, if any. A graphical representation of the subject is then obtained for each sentence. Each of these approaches, however, fail to teach providing an image which shows text, much less the ability to scale the size of such an image translation to fit a desired size of display box.

In sum, none of these prior art approaches permit a user the ability to provide scalable text based information in a graphical format which can be viewed promptly by a user's browser.

What is needed is flexible solution for the conversion and scaling of a text message (such as an advertisement) to a graphical image for distribution to and display on a viewer's browser.

### Definition of Terms

The following terms are used in the claims of the patent as filed and are intended to have their broadest plain and ordinary meaning consistent with the requirements of the law.

A “text based message” means a message received for processing which includes typographical characters and encoding information for display on a webpage.

“Style characters” refers to display characteristics of a text based message other than the font size or typographical characters. Examples of style characters include aspects such as italics, underlining, or font color.

“Predetermined text spacing information” means information corresponding to the typographical character size and spacing for given typographical characters and font sizes, wherein such information is stored prior to processing the text based message.

“Desire text box” means a predefined space inside which a composite image may be placed. It can include, but is not limited to IAB standard ad sized, a portion thereof (e.g., the text portion of an standard IAB ad size), or the entirety of a web page.

Where alternative meanings are possible, the broadest meaning is intended. All words used in the claims set forth below are intended to be used in the normal, customary usage of grammar and the English language.

### OBJECTS AND SUMMARY OF THE INVENTION

The apparatus and method of the present invention generally includes a tool and method for converting a text message to a composite graphical image for distribution to and display upon a viewer's browser or the like in a desired size display box. Specifically, the invention includes the ability to take a text message, parse out the style information (e.g., text color, bold, underlining, etc.), separating the text message into individual characters, matching the characters to a predetermined size and spacing information matching the arrangement of characters (e.g., specific to the order of letters and font size in the message).

Next, the message is grouped into words and lines so as to provide a message size, and the size of that message is then compared to the size of a desired text box. If the message size exceeds the size of the desired text box, the message is scaled down to a smaller font and new size and spacing information is matched to the reduced font size. Once the message size is capable of fitting within the desired text box, the system calculates the final position (e.g., the raster position) within the desired text box for each typographic character, and then image files corresponding to each of the text characters are loaded and positioned in the desired text box. Finally, the system renders or edits the images into a single, composite image which is capable of being delivered to remote viewers for browsing.

The immediate application of a present invention will be seen in the field of online advertising, though those of skill will see that the present invention could be applied to other fields requiring reliable conversion of text messages to size adjustable images conveying the same content.

Thus can be seen that one object of the present invention is to provide a tool for converting text characters to raster specific images for rendering and display on a user's browser.

A further object of the present invention is to provide a method for converting a text message to an image having the same content and format for rendering and viewing by a remote user on a browser or the like.

Still another object of the present invention is to provide a method and tool for providing the rendering of text based messages to a user's browser without the use of web fonts.

Yet another object of the present invention is to provide for a system which provides for the automated scaling of a text message to generate an image having a desired size.

Still another object of the present invention is to provide a system and method for providing for the quick and easy recall to render a previously viewed message in recalling an image already converted from text format for viewing.

It should be noted that not every embodiment of the claimed invention will accomplish each of the objects of the invention set forth above. In addition, further objects of the invention will become apparent based on the summary of the invention, the detailed description of preferred embodiments, and as illustrated in the accompanying drawings. Such objects, features, and advantages of the present invention will become more apparent in light of the following detailed description of a best mode embodiment thereof, and as illustrated in the accompanying drawings.

### BRIEF DESCRIPTION OF THE DRAWINGS

FIG. 1 shows a flow chart of a conversion process of a text message to a composite image in accord with a preferred embodiment of the present invention.

FIG. 2 shows examples of types of preloaded text data used in the system and method of an embodiment of the present invention.

FIG. 3 shows visual representation of the comparison and font reduction of a text message in comparison with a desired text box in accord with a preferred embodiment of the present invention.

FIGS. 4a and 4b show an advertisement using prior art web font technology across different computer platforms, in comparison to the composite image of the present invention as shown in FIGS. 4c and 4d as being used across different computer platforms.

FIGS. 5a-5c show the results of pseudocode listings practicing an embodiment of the present invention.

### DETAILED DESCRIPTION OF THE INVENTION

Set forth below is a description of what is currently believed to be the preferred embodiment or best examples of the invention claimed. Future and present alternatives and modifications to this preferred embodiment are contemplated. Any alternatives or modifications which make insubstantial changes in function, in purpose, in structure or in result are intended to be covered by the claims in this patent.

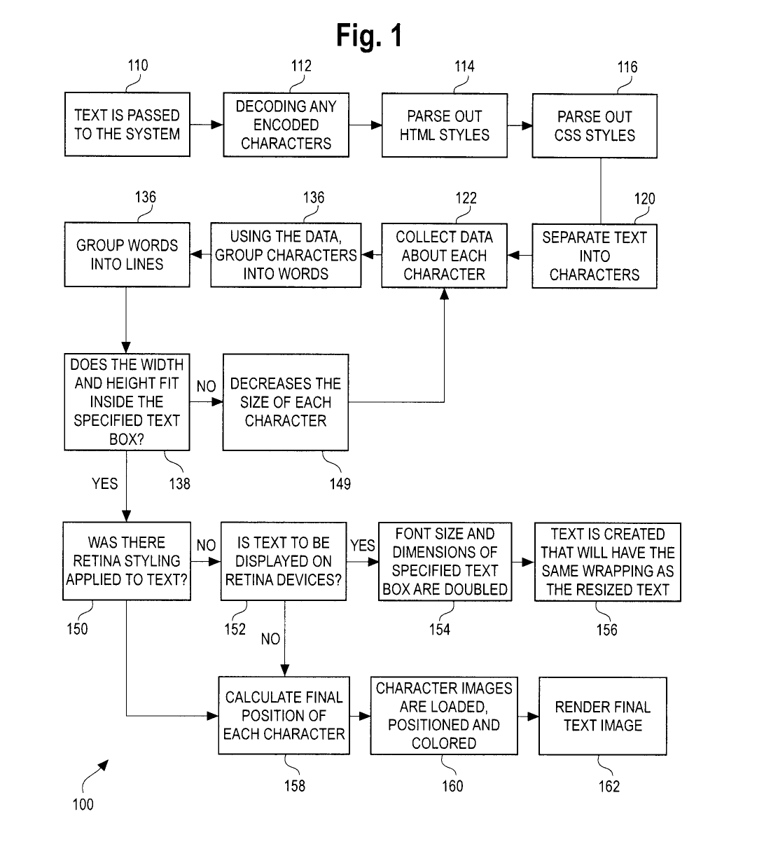

FIG. 1 shows a flowchart 100 practicing a method in accord with a first preferred embodiment of the present invention. This embodiment of the process involves 110 the receipt or similar access of a text based message (such as a text message that would be made available to a viewer via a URL redirect) at a server or the like. Upon reception of the text based message, the method next involves 112 decoding any encoded characters, such as URL encoding and similar characters which may be used to avoid malforming of the text based message during rendering. Next, the parsing steps of 114 parsing out HTML styles and 116 parsing out CSS styles are employed to remove aspects of the characters related to the style, as opposed to the identity, of a given typographical character. Examples of such styles include bold, italics and font color.

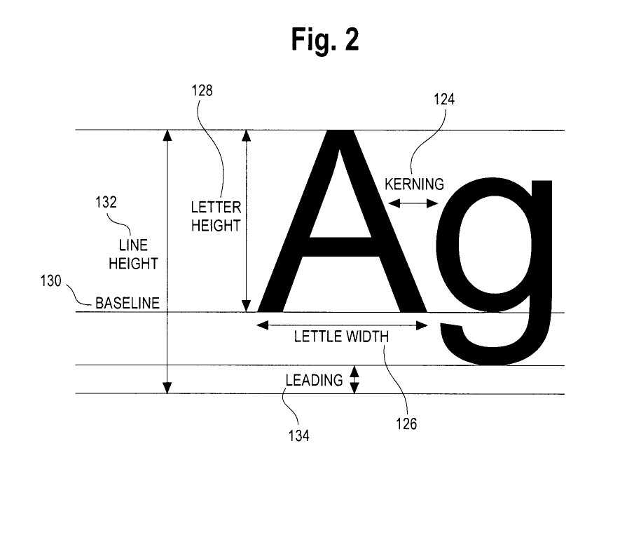

After parsing, the process involves 120 separating the text from the text based message into characters, and 122 collecting preloaded data about each character. Such data about each character is preloaded for discrete fonts and font sizes and is stored in a memory either in a memory in the server or connected to the server. As shown in FIG. 2, such preloaded text data can include 124 kerning, 126 letter width, 128 letter height, 130 baseline, 132 line height and 134 leading (i.e., spacing between two lines of characters).

Referring back to FIG. 1, once the typographic characters of the text based message are matched to specific corresponding data from among the preloaded data, the process next involves the steps of 136 using the corresponding data to group the individual typographical characters into words and grouping the words into lines of text so as to create a text message of a given size in terms of a number of raster addresses (X number of rows x Y number of columns). Once this text message size is established, the step 138 of comparing the message text size against a desired text box size (e.g., the size of a banner or similar ad for conveying the message on a web page).

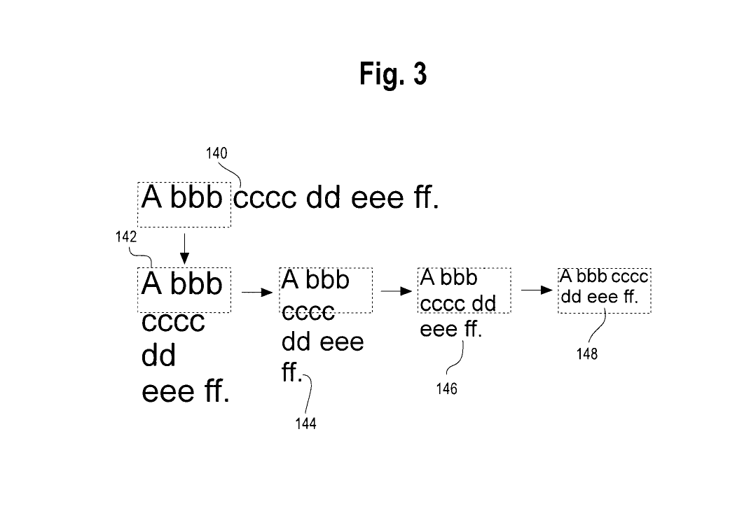

If the text message size is greater—either in height or width—than the desired text box, then the steps of 122 collecting preloaded data about each character and 136 using the corresponding data to group the individual typographical characters into words and grouping the words into lines of text so as to create a text message of a given (now smaller) size are repeated. That is, the process repeats these steps with the next smallest size of font for which preloaded data has been stored. Those of skill in the art having the teaching of the present invention will understand that the raster based solution disclosed herein required preloaded data corresponding to discrete size and spacing values that allow the method to progressively and repeatedly scale down the typographic figures making up the image until the size of the text message is less than the size of the desired box. FIG. 3 shows a visual representation of an example of this iterative process involves comparing the text message size 140 is compared against the desired text box 142, with the resealed text messages 144, 146, 148 becoming progressively smaller until the message size fits within the desired text box.

Referring again to FIG. 1, once the message size fits within the desired text box, the process involves the optional steps of 150 determining whether retina styling was applied to the text based message and 152 determining whether the message is to be displayed on retina devices (both steps, like the comparing step 138 being preferably performed by a processor on the server). If the determining steps 150 and 152 find that retina styling has been applied and that the message will be displayed on a retina device, then the process provides the further optional steps of 154 doubling the font size and desired text box size, and 156 providing the same text wrapping as the resized text. With the message thus effectively magnified, this retina device intended message is reprocessed by repeating the steps of 120 separating the text from the text based message into characters, and 122 collecting preloaded data about each character.

If, however, the text message 148 sized to fit within the desired text box 142 does not require further retina display processing, then the process involves 158 calculating the final raster position of each typographical character. These raster positions are then 160 loaded and positioned using graphic or image files (e.g., .png or .jpeg files) preloaded in memory, wherein each stored image file corresponds to a given individual typographical character in the message to be displayed. This step further optionally includes the ability to reintroduce styling features that were removed in parsing steps 114 and 116 so that the format of text based message as received is more precisely reproduced. Finally, the server 162 renders the final image by using one of several publicly available image file editing programs (e.g., ImageMagick) which allow the individual image files to be overlaid, joined or otherwise attached to one another to create a single, composite image file. Thus, when the resulting composite image is provided by the server to a remote user's device, this message is displayed (and can be recalled) more quickly by a browser or similar device, and can thus be displayed without the use of any web fonts.

Another, more specific embodiment is set forth below as a series of pseudocode listing. The first step in this embodiment is that 210 Text is passed to the script

URL:

script?text=<span style=“color:FF0000”>Aa</span> <b>b<u>b</u></b> %26%2362%3B
&font_family=10074&max_font_size=80%03&width=100&height=80&color=000000&ali
gn=left
Params:
text=<span style=“color:FF0000”>Aa</span> <b>b<u>b</u></b> &#62;

font_fa
mily=1
0074
max_fo
nt_size
=80
width=
100
height=
80
color=0
00000
align=le
ft

Next, the process involves 211 applying font properties as CSS styles to the text string for subsequent parsing and use:

Text input: <span style=“color:FF0000”>Aa</span> <b>bb</b> &#62;
Process: The following parameters will be converted to CSS styles:

| | | |
|---|---|---|
| max_font_size=80 | will be | font-size:80 |
| font_family=10074 | will be | font-family:10074 |
| color=000000 | will be | color:000000 |

Final text:
<span style=“font-size:80; font-family:10074; color:000000”><span
style=“color:FF0000”>Aa
</span> <b>b<u>b</u></b> &#62;</span>

The next step in this embodiment involves 212 decoding HTML entities:

Text input: final text from step 211
Process: &#62; will be turned into >
New text:
<span style=“font-size:80; font-family:10074; color:000000”><span
style=“color:FF0000”>Aa
</span> <b>b<u>b</u></b> ></span>

The next step of the process involves 214 parsing out CSS styles:

Text input: final text from step 212
Supported CSS styles: font-family, font-size, color, text-decoration
Process: Split the text on all span tags and process the supported CSS
styles
Final text array:
[ {text: ‘Aa’ , fontId:10074, fontSize:80, color:’ff0000’},

{text: ‘ <b>b<u>b</u></b> >’ , fontId:10074, fontSize:80,
color:’000000’}]

A further parsing step in this embodiment involves 216 parsing out HTML styles:

Text array input: final text array from step 214
Supported HTML tags: <br>, <b>, <strong>, <i>, <u>, <sup>, <sub>,
<strike>
Process: Split text on the supported HTML tags to apply correct styling
Final text array:
[{text: ‘Aa’ , fontId:10074, fontSize:80, color:’ff0000’},

{text: ‘ ’ , fontId:10074, fontSize:80, color:’000000’},
{text: ‘b’ , fontId:10074, fontSize:80, color:’000000’, style:[ ‘bold’
]},
{text: ‘b’ , fontId:10074, fontSize:80, color:’000000’, style:[ ‘bold’,
‘underline’ ]},
{text: ‘ >’ , fontId:10074, fontSize:80, color:’000000’}]

After parsing, this embodiment includes 218 finding a correct fontId by using a font list

Text array input: final text array from step 216
Supported font styles: regular, bold, italic, bold-italic
Process: For each text entry in the array, the fontId’s will be checked
against a font list depending on the type of styling applied to the text.

New text array:
[{text: ‘Aa’ , fontId:10073, fontSize:80, color:’ff0000’},

{text: ‘ ’ , fontId:10073, fontSize:80, color:’000000’},
{text: ‘b’ , fontId:10028, fontSize:80, color:’000000’},
{text: ‘b’ , fontId:10028, fontSize:80, color:’000000’},
{text: ‘ >’ , fontId:10073, fontSize:80, color:’000000’}]

Next, the process involves 220 a step of separating the text into typographical characters:

Text array input: final text array from step 218
Process: Goes through each text block and separates it into individual
characters.
New text array:
[{text: ‘A’ , fontId:10073, fontSize:80, color:’ff0000’},

{text: ‘a’ , fontId:10073, fontSize:80, color:’ff0000’},
{text: ‘ ’ , fontId:10073, fontSize:80, color:’000000’},
{text: ‘b’ , fontId:10028, fontSize:80, color:’000000’},
{text: ‘b’ , fontId:10028, fontSize:80, color:’000000’,
style:[’underline’]},
{text: ‘ ’ , fontId:10073, fontSize:80, color:’000000’},
{text: ‘ >’ , fontId:10073, fontSize:80, color:’000000’}]

After the text is separated into typographical characters, a series of step occur that provide for text resizing:

Text array input: final text array from step 220
Process: Loops the steps below until the text fits in the specified area.
(ex: width:100 height:80)
SubStep a: 222 Collecting preloaded data about each character

Process: Goes through each character and loads the font
data for the specified fontId.
New text array:
[{text: ‘A’ , fontId:10073, fontSize:80, color:’ff0000’,

fontData:{lineHeight:80, base:58, height:59, width:55,
offset:−1, xoffset:0,xadvance:53, id:65,
kerningArray:[ ]}},

{text: ‘a’ , fontId:10073, fontSize:80, color;’ff0000’,

fontData:{lineHeight:80, base:58, height:45, width:40,
yoffset:14, xoffset:3,xadvance:44, id:97,
kerningArray:[ ]}},

{text: ‘ ’ , fontId:10073, fontSize:80, color:’000000’,

fontData:{lineHeight:80, base:58, height:0, width:0,
yoffset:58, xoffset:0,xadvance:22, id:32,
kerningArray:[ ]}},

{text: ‘b’ , fontId:10028, fontSize:80, color:’000000’,

fontData:{lineHeight:80, base:58, height:60, width:42,
offset:−1, xoffset:5,xadvance:49, id:98,
kerningArray:[ ]}},

{text: ‘b’ , fontId:10028, fontSize:80, color:’000000’,

fontData:{lineHeight:80, base:58, height:60, width:42,
offset:−1, xoffset:5,xadvance:49, id:98,
kerning Array:[ ]}},

{text: ‘ ’ , fontId:10073, fontSize:80, color:’000000’,

fontData:{lineHeight:80, base:58, height:0, width:0,
yoffset:58, xoffset:0,xadvance:22, id:32,
kerningArray:[ ]}},

{text: ‘>’ , fontId:10073, fontSize:80, color:’000000’,

fontData:{lineHeight:80, base:58, height:40, width:39,
yoffset:9, xoffset:4,xadvance:47, id:62,
kerning Array:[ ]}}]

SubStep b: 236 grouping characters into words

Process: Groups the characters into words with the rule that a word is
separated by a space.
New text array:
[{text: ‘Aa’, lineHeight:80, base:58, xoffset:97,

yoffset:0, width:97, height:59, x:0, characters:[array of
character data]},
{text: ‘ ’, lineHeight:80, base:58, xoffset:22,
yoffset:0, width:22, height:0, x:0, characters:[array of
character data]},
{text: ‘bb’, lineHeight:80, base:58, xoffset:98,
yoffset:0, width:98, height:59, x:0, characters:[array of
character data]},
{text: ‘ ’, lineHeight:80, base:58, xoffset:22,
yoffset:0, width:22, height:0, x:0, characters:[array of
character data]},
{text: ‘>’, lineHeight:80, base:58, xoffset:47, yoffset:0,
width:47, height:49, x:0, characters:[array of character
data]}]

SubStep c: 236 Group words into lines

Process: Groups the words into lines with the rule that a line is
separated by a break tag or when the width of the line is larger
than the width of the desired area.
New text array:
[

```
  {width:97, height:80, y:0, words:[array of word data]},
  {width:98, height:80, y:80, words:[array of word data]},
  {width:47, height:49, y:160, words:[array of word data]}
```

]

SubStep d: 238 comparing to determine: Does the width and height fit
inside the specified text box?

Process:

```
  Yes: Continues to step 250
  No: Decreases the font size of each character and goes back
  to substep a
```

Once the text array fits inside a desired or specified text box, the process includes a series of steps to determine whether further processing is needed to account for high resolution styling (e.g., Retina styling, 4k styling or similar resolution enhancement styling).

Text array input: final text array from step 238
Process: Checks if retina support is needed. If it is, data will be changed
to fit a space that is double the size of the original.
Step 250: Was there retina styling applied to text which has not already
been processed?

Process:

Yes: Continue to step 252
No: Continue to step 258

Step 252: Is text to be displayed on retina devices?

Process:

Yes: Continue to step 254
No: Continue

to step 258

Step 254: Update text string to support retina

Text input: final text

from step 238

Process: Multiplies the following properties by 2: fontSize, width,
height, tracking. Adds non breaking spaces (&nbsp;) and break tags
to make sure the word wrapping remains the same as the original
resized text.
New text:
<span style=“font-size:74; font-family:10073;
color:ff0000”>Aa<br></span>
<span style=“font-size:74; font-family:10028;
color:000000”>b<u>b</u>&nbsp;
</span><span style=“font-size:74; font-family:10073;
color:000000”>></span>

Step 9d: Go back to step 220

Once the final array of typographical characters finishes passing through any high resolution processing, the process involves 258 calculating the final raster position of each typographical character:

Text array input: final text array from step 254 or 238 (if no high
resolution styling was applied)

SubStep a: Character positions

Process: Goes through each character and calculates its final
position
Final text array:
[

{text: ‘A’, x:0, y:1, id:65, fontId:10073, fontSize:37,
color:‘ff0000’},
{text: ‘a’, x:26, y:7, id:97, fontId:10073, fontSize:37,
color:‘ff0000’},
{text: ‘b’, x:0, y:38, id:98, fontId:10028, fontSize:37,
color:‘000000’},
{text: ‘b’, x:23, y:38, id:98, fontId:10028, fontSize:37,
color:‘000000’},
{text: ‘>’, x:58, y:43, id:62, fontId:10073, fontSize:37,
color:‘000000’}

]

SubStep b: Shape positions

Process: Gathers any lines/shapes that need to be rendered with
the text
Final shape array:
[

{x:23, y:68, width:20, height:1.11, color:‘000000’}

]

Finally, this embodiment involves the step of 262 rendering the final image:

Text array input: final text/shape array from step 10
SubStep a: Generating the canvas

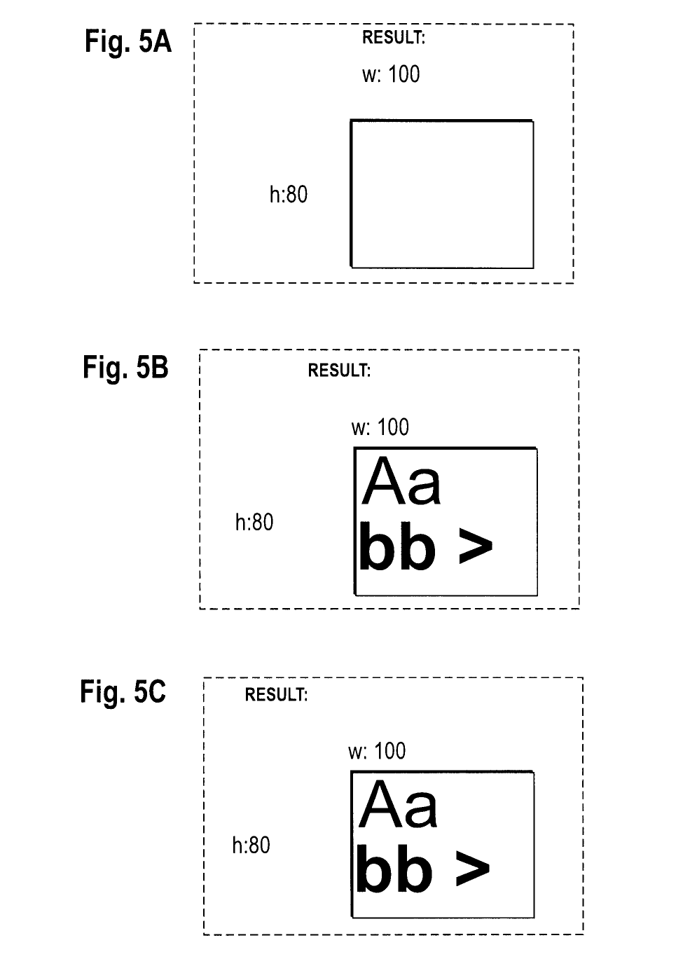

Process: Creates a blank canvas which equals the width and height of
the text area, with the result as shown in Figure 5a.

SubStep b: Renders characters

Process: Loops through the array of characters one by one, loads it
onto the canvas and applies the correct tint to it, with the result as
shown in Figure 5b.

Step 11c: Renders shapes

Process: Loops through the array of shapes one by one, loads it onto
the canvas and applies the correct tint to it, with the result as shown
in Figure 5c.

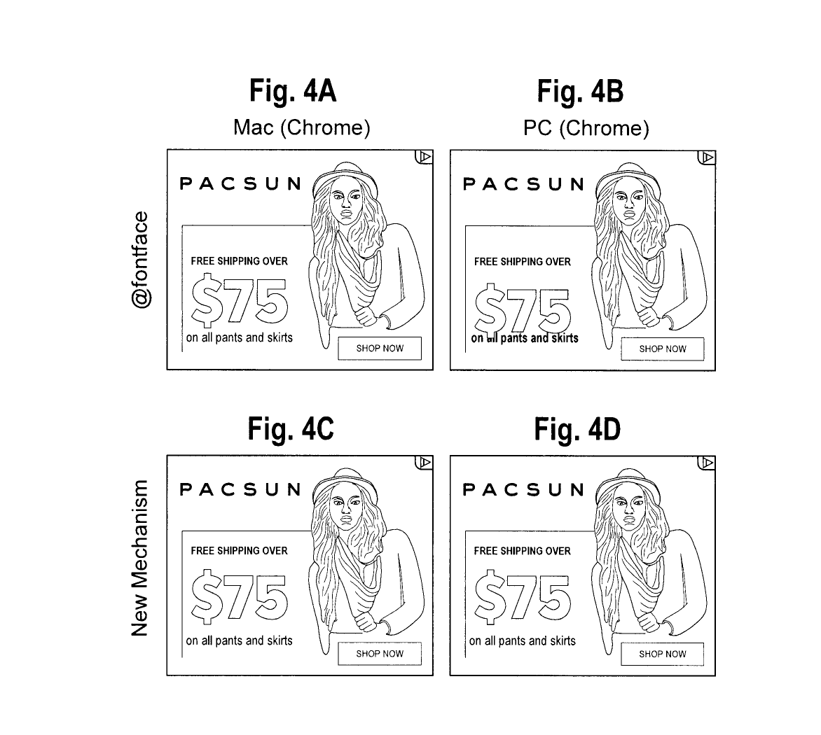

One of the advantages of this embodiment of the present invention is shown by way of example in FIGS. 4a-4d. That is, the output provided created by the present invention is capable of providing composite images conveying the same content in the same format across different platforms (as shown in FIGS. 4c and 4d), as distinguished from existing webfont solutions which may alter the format of a message across such platforms (as shown in FIGS. 4a and 4b).

The above description is not intended to limit the meaning of the words used in the following claims that define the invention. Rather, it is contemplated that future modifications in structure, function or result will exist that are not substantial changes and that all such insubstantial changes in what is claimed are intended to be covered by the claims. For instance, the specific font sizes used in the examples of the preferred embodiments of present invention is for illustrative purposes with reference to the example drawings only. Similarly, while the preferred embodiments of the present invention are focused upon the rendering of images for online advertisements, those of skill in the art will understand that the invention has equal applicability to messages which have a need to be rendered quickly and without reliance upon web fonts. Likewise, it will be appreciated by those skilled in the art that various changes, additions, omissions, and modifications can be made to the illustrated embodiments without departing from the spirit of the present invention. All such modifications and changes are intended to be covered by the following claims.

We claim:

1. A method for rendering text characters as a composite image comprising the steps of:
a) receiving a text message including typographical characters having a given;
b) parsing style characters from the text message;
c) matching the typographical characters with predetermined text spacing information to provide a message size;
d) comparing the message size with a desired text box size;
e) where the message size is larger than the desired text box size, reducing the size of each typographical character and rematching predetermined text spacing information corresponding to the reduced size typographical characters to provide a smaller message size;
f) calculating the final position of each typographical character within the desired text box size;
g) loading image files corresponding to each typographical character within the desired text box size; and
h) rendering a final composite image using the image files corresponding to each typographical character for delivery to remote viewers.

2. The method of claim 1, comprising the further step of using style characters parsed from the text message in connection with the step of loading image files so as to create a composite image having the same style as the text message.

3. The method of claim 1, comprising the further step of determining whether high resolution styling was applied to the typographical characters and altering the dimensions of the desired text box upon detecting the presence of high resolution styling.

4. The method of claim 1, wherein the step of matching the typographical characters with predetermined text spacing information to provide a message size includes adjusts the wrapping of the typographical text to as to match the text wrapping of the text message.

5. A system for rendering text characters for viewing as a composite image comprising:
a) a server for receiving a text message containing an array of typographical characters;
b) a parsing module located on the server for removing encoded characters and style characters and separating typographical text into characters;
c) a memory connected to the server, the memory containing predetermined space and size information corresponding to a plurality of typographical characters including the array of typographical characters from the message;
d) a sizing module connected to the memory for using the space and size information corresponding to the array of typographical characters; and
e) a processing module connected to the output of the sizing module to position and load typographical character images so as to create a composite image corresponding to the text message for viewing by a browser.

6. The system of claim 5, wherein the sizing module is further capable of adjusting the size of each typographical character so as to fit a desired text box.

7. The system of claim 6, wherein the processing module accesses the style characters separated by the parsing module so as to create a composite image having the same style as the text message.

8. The system of claim 6, wherein the sizing module further determines whether high resolution styling was applied to the typographical characters and alters the dimensions of the desired text box upon detecting the presence of high resolution styling.

9. The system of claim 6, wherein the sizing module further adjusts the wrapping of the typographical text to as to match the text wrapping of the text message.

10. A method for rendering text characters as a composite image comprising the steps of:
a) receiving a text message including typographical characters having a given;
b) parsing style characters from the text message;
c) matching the typographical characters with predetermined text spacing information to provide a message size which is loaded into a desired text box size;
d) calculating the final position of each typographical character within the desired text box size;
e) loading image files corresponding to each typographical character within the desired text box size; and
f) rendering a final composite image using the image files corresponding to each typographical character for delivery to remote viewers.
